(19) United States
(12) Patent Application Publication
(10) Pub. No.: US 2003/0019346 A1
(43) Pub. Date: Jan. 30, 2003

(54) Collapsible/folding mini USB/MIDI keyboard controller

(76) Inventor: Kirk Jeffrey, Studio City, CA (US)

Correspondence Address: Kirk Hunter, 4189 Vineland Ave #114, Studio City, CA, 91602, US

(21) Appl. No.: 10/205,819

(22) Filed: Jul. 26, 2002

Related U.S. Application Data
(60) Provisional application No. 60/307,957, filed on Jul. 27, 2001.

(51) Int. Cl. G10C 3/12

(52) U.S. Cl. 84/423 R

(57) ABSTRACT

This invention is a musical electronic MIDI keyboard's hinge, which splits the keyboard into two equal parts. Each equal part will then fold over each other for the purpose of easy transportation, conservation of space, and self-protection.

Please associate this utility patent application with the provisional utility application No. 60/307,957 filed on Jul. 27, 2001. The invention named in the provisional application is the same invention mentioned in this non-provisional application.

### BACKGROUND OF THE INVENTION

The field of endeavor for this invention applies mostly to electronic music-oriented musicians (mostly those who use computers to interface with their musical keyboards). These musicians use MIDI musical keyboards, but find it difficult to transport or travel with existing musical keyboards due to their size and physical limitations. Currently, electronic musical keyboards, even small ones, are quite cumbersome, and are easily damaged due to their physical shape and vulnerability. Because musical keyboards are very long, they do not port easily, especially if one wishes to carry them during such trips that involve small passenger areas such as those in airplanes.

### BRIEF SUMMARY OF THE INVENTION

Since the physical shape of an electronic musical keyboard is rather flat, yet long enough to render it difficult in travels, by creating a keyboard with a hinge-like center, by which one section can fold over the other, the problem is solved. Additionally, when the two parts are folded together, protection of the surface of the musical is accomplished. Therefore, the two main benefits of this invention are to create a truly portable keyboard that itself becomes its own protective carrying case.

### DETAILED DESCRIPTION OF THE INVENTION

The two halves of the keyboard will communicate information about the state of each key switch. The information may be of several types including which keys are depressed, how fast the keys were depressed, and how hard the keys are being depressed. Transmitting the data between the two halves will allow a complete keyboard image to be processed by the keyboard controller (MIDI in the preferred embodiment). This communication will occur over a connection, which may take many forms, not limited to the following options:

A multi-conductor flexible polyamid circuit

Optical (example: IrDA)

Wireless

A simple cable of multi-stranded wires

Rotating contactors embedded into the hinge mechanism

1. What I claim as my invention is the physical hinging characteristic which splits a musical electronic midi keyboard into two equally-sized sections enabling the user of the keyboard to more easily travel with it, as well as obtaining protection for the keyboard once one part is folded over the other.
